(19) United States
(12) Patent Application Publication
(10) Pub. No.: US 2006/0052561 A1
(43) Pub. Date: Mar. 9, 2006

(54) Chemically Inert Pressure Sensitive Adhesive Having Improved Adhesion, Process For It's Manufacture, And Use Thereof

(75) Inventors: Hansjorg Ander, Bendorf (DE); Gunter Holl, Horhausen (DE)

Correspondence Address: D. Peter Hochberg Co., 1940 East 6th St., 6th Floor, Cleveland, OH, 44114, US

(73) Assignee: Lohmann GmbH & Co., KG

(21) Appl. No.: 10/534,347

(22) PCT Filed: Oct. 31, 2003
(86) PCT No.: PCT/EP03/12116

§ 371 Date: May 9, 2005

(30) Foreign Application Priority Data
Nov. 14, 2002 (DE) 102 52 978.7

(51) Int. Cl. C08F 120/54; C08F 118/02

(52) U.S. Cl. 526/303.1; 526/319

(57) ABSTRACT

Chemically inert pressure sensitive adhesives having improved adhesion to polar and semipolar substrates, as well as to the manufacture and use thereof, especially for manufacturing pressure sensitive adhesive tapes possessing high initial adhesion (tack) on polar and semipolar substrates.

### CROSS-REFERENCE TO RELATED APPLICATIONS

This application is a National Stage application of International Application No. PCT/EP03/012116, filed on Oct. 31, 2003, which claims priority of German application number 102 52 978.7, filed on Nov. 14, 2002.

### BACKGROUND OF THE INVENTION

1. Field of the Invention

The present invention relates to pressure sensitive adhesives which are resistant to chemicals and process additives and at the same time exhibit improved adhesion to polar and semipolar substrates, especially on glass.

More particularly, the invention relates to the manufacture of chemically inert pressure sensitive adhesives and their use, especially for the production of pressure sensitive adhesive tapes with high initial adhesion (tack) on polar and semipolar substrates such as glass, metal, polycarbonate and similar materials.

2. Description of the Prior Art

The tack of a pressure sensitive adhesive tape is dependent on the substrate to which the pressure sensitive adhesive tape is applied. For substrates with polar surfaces, such as glass or metal, a value of about 25 to 30 N/25 mm, as can be achieved with the at present commonly used pure acrylate-based pressure sensitive adhesive tapes, is regarded as high. With substrates that have nonpolar surfaces, such as polyethylene or polypropylene, values of more than 15 N/25 mm are already considered high. The pure acrylate-based pressure sensitive adhesive tapes which are commonly used today have a tack on substrates with nonpolar surfaces that is in the range between 5 and 12 N/25 mm.

Pressure sensitive adhesive tapes having high tack on polar substrates are widely utilized in industrial processes. The pressure sensitive adhesives utilized for such pressure sensitive adhesive tapes usually consist of polyacrylates or mixtures of polyacrylates with resins (tackifiers). The polyacrylates are produced by free-radical polymerisation of mixtures of monomeric acrylates, for example esters of acrylic acid, methyl acrylic acid, ethyl acrylic acid, butyl acrylic acid and the like, or of the acids themselves. Polymerization is performed in solvents by thermal activation, or in mass by activation via high-energy irradiation (UV or EB curing).

To achieve a high initial adhesion (tack), acrylic acid may be used. The high tack is here brought about by the interaction of the strongly polar carboxyl group of the acrylic acid with the polar or semipolar substrates (dipole-dipole-interaction, formation of hydrogen bridges).

The use of acrylic acid to achieve high initial adhesion to polar surfaces is, however, connected with serious disadvantages. Because of the strongly polar character of acrylic acid, these adhesives show high affinity to polar and semipolar solvents. Long-lasting exposure to such adhesives to polar or semipolar solvents as a rule results in failure of the adhesive joint due to swelling (cohesive failure) or detachment of the adhesive from the surface of the substrate as a result of migration of the solvent in the barrier layer between adhesive and the substrate surface (adhesive failure).

A further disadvantage of pressure-sensitive adhesives containing acrylic acid is the strong reactivity of acrylic acid to reactive chemical compounds. Particularly in the manufacture of compound glass and compound glass products wherein cast resins based on isocyanate-containing polymers are utilized, there occurs a reaction of the isocyanate groups with the acrylic acid in the pressure sensitive adhesive. This reaction manifests itself in an undesired formation of bubbles due to carbon dioxide formation caused by the following reaction: R₁—NCO+R₂—COOH→R₁—NH—CO—R₂+CO₂. This bubble formation cannot only affect the functional capability of the constructional elements, but is also not desired for aesthetic reasons, above all in adhesive joints at visible sites.

It was therefore the task of the present invention to provide a pressure sensitive adhesive which has high tack while simultaneously is inert to chemical influences and moisture. At the same time the adhesive should not show a visible reaction on contact with isocyanate-containing compounds.

### SUMMARY OF THE PRESENT INVENTION

The task according to the present invention is solved by pressure sensitive adhesives based on copolymerisates of methacrylates and acrylates. The desired high tack of the inventive pressure sensitive adhesives is achieved by polar acrylates such as 2-hydroxyethyl acrylate, 3-hydroxypropyl acrylate, 4-hydroxybutyl acrylate, PEG acrylates, 2-aminoethyl acrylate, 3-aminopropyl acrylate, 4-aminobutyl acrylate, or by methacrylates corresponding to the preceding compounds. Important for achieving a high tack are polar groups in the acrylates which are capable of forming hydrogen bridges to the substrates. These are, in particular, hydroxy, amino and thio groups, as well as, to a minor extent, urea groups, urethane groups and imino groups, that is, generally, acrylates having at least one Tserevitinov hydrogen.

### DETAILED DESCRIPTION OF THE PRESENT INVENTION

It should be appreciated that the term “Tserevitinov hydrogen” means the so-called active hydrogen which can be determined, using a method found by Tschugaeff and Tserevitinov, by conversion with methyl magnesium iodide in butyl ether or other ethers. Belonging to the Tserevitinov hydrogens is the active N—, O— or S-bound active hydrogen of carboxy, hydroxy, amino and imino as well as thiol groups, but also the active hydrogen of H-acidic hydrocarbons, which in some cases can be quantified by the methods of Tschugaeff and Tserevitinov.

According to the present invention, polar(meth)acrylates which do not contain carboxyl groups, but which are selected from the group of the hydroxy(meth)acrylates, may be employed.

The necessary consistency of the pressure sensitive adhesives in terms of softness and processibility is, according to the invention, achieved by using nonpolar acrylates and/or methacrylates. Suitable for this purpose are, for example, esterification products of acrylic acid and monohydric alcohols, as well as the corresponding products which are formed when using methacrylic acid. According to the invention, the products of C₄-C₁₅ alcohols may be employed, such as the conversion products of C₆-C₁₀ alcohols.

To achieve an inner strength of the pressure sensitive adhesives (cohesion), a crosslinking agent can be added to the acrylate and/or methacrylate mixtures during polymerisation. The crosslinking agents are on the one hand acrylates or methacrylates of the dihydric, trihydric or higher valent alcohols, or analogous vinyl ethers (in the following also designated as difunctional, trifunctional and higher functional (meth)acrylates) or mixtures thereof. On the other hand, the polymers can also be crosslinked subsequent to polymerisation, including the polar acrylates, by means of isocyanates, epoxides, aziridines, metal complexes or other multifunctional compounds reacting with Tserevitinov hydrogen, or by means of mixtures thereof.

As a matter of course, mixtures of (meth)acrylate-containing crosslinking agents with compounds that are reactive to H-acidic compounds are also possible.

The degree and type of crosslinking in the production of the inventive polymer composition is determined by the degree of softness and inner strength of the adhesive polymers that is required for their later application, as well as by further parameters such as heat resistance, low-temperature resistance, tack and the like.

The inventive adhesives can be prepared from:
(a) 1 to 50%-wt of polar(meth)acrylates with a Tserevitinov hydrogen,
(b) 50 to 99%-wt of apolar(meth)acrylates,
(c) up to 10%-wt of a bi-, tri- or higher functional (meth)acrylates or of a (poly)functional compound which is reactive to Tserevitinov hydrogens, the weight percentages indicated under a) to c) adding up to 100%-wt,
(d) 0.05 to 5%-wt of an initiator, relative to the sum of the components of a) to c), the weight percentages indicated under a) to d) adding up to 100%-wt, and
(e) up to 90%-wt of a liquid, chemically inert medium, relative to the components a) to d).

It should be appreciated that “polar(meth)acrylates with Tserevitinov” hydrogen according to a) means reaction products of acrylic or methacrylic acid with di-, tri- or higher functional alcohols as well as their ethoxylation products, with terminal hydroxy, amino, thio or heterocyclic groups containing at least one active hydrogen. As a matter of course, for the purposes of the invention it is also possible to utilize mixtures of these compounds.

Table 1 lists some examples of technically important compounds.

Table 1: Examples of Technically Significant (Meth)Acrylates with Active Hydrogen

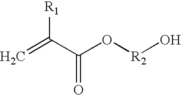

R₁ = CH₃, H
R₂ = C₂H₄, C₃H₆, C₄H₈
Hydroxyalkyl (meth)acrylates

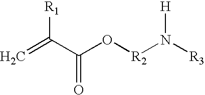

R₁ = CH₃, H
R₂ = C₂H₄, C₃H₆, C₄H₈
R₃ = H, CH₃, C₂H₅, C₃H₇, C₄H₉
Aminoalkyl (meth)acrylates

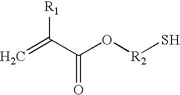

R₁ = CH₃, H
R₂ = C₂H₄, C₃H₆, C₄H₈
Thioalkyl (meth)acrylate

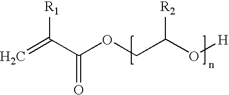

R₁ = CH₃, H
R₂ = CH₃, H
n = 1-15
PEG/PPG-(meth)acrylates

It should also be appreciated that apolar(meth)acrylates according to b) are understood to be conversion products of monofunctional alcohols or amines with acrylic acid or methacrylic acid, as well as mixtures thereof.

Technically significant representatives of this class are methyl(meth)acrylate, ethyl acrylate, butyl acrylate, hexyl(meth)acrylate, isooctyl acrylate, 2-ethylhexyl acrylate, isodecyl(meth)acrylate, isobomyl (meth)acrylate, alkyl(meth)acrylamides. But still other monomers which are accessible to free-radical polymerisation, e.g. vinyl compounds, can be added in minor amounts to the inventive (meth)acrylate mixtures, should this be necessitated by special demands put on the adhesive polymer.

A di-, tri- or higher functional (meth)acrylate according to c) is understood to mean compounds obtained by the reaction of polyhydric alcohols with (meth)acrylic acid. Some technically important compounds of this class are listed in Table 2.

Table 2: Examples of Technically Relevant Higher Functional (Meth)Acrylate-Containing Compounds

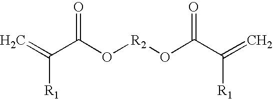

R₁ = H, CH₃
R₂ = C₂H₄, C₃H₆, C₄H₈, C₆H₁₂
Alkyl di(meth)acrylates

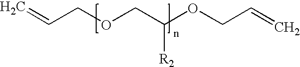

R₁ = H, CH₃
R₂ = H, CH₃
n = 2-15
Divinyl ethers

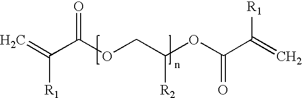

R₁ = H, CH₃
R₂ = H, CH₃
n = 2-15
Alkoxyl di(meth)acrylates

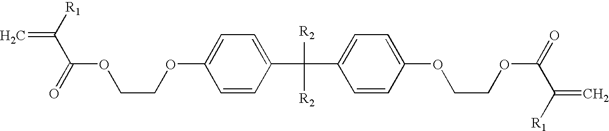

R1 = H, CH3
R2 = H, CH3
Epoxidized bisphenol
di(meth)acrylates

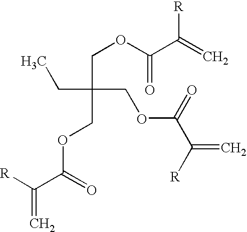

R = H, CH₃
Trimethylol propane tri(meth)acrylates

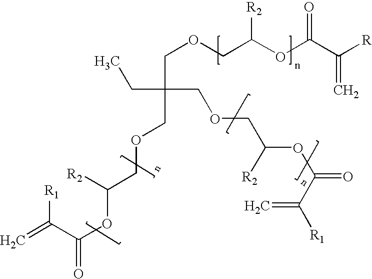

R₁ = H, CH₃
R₂ = H, CH₃
Alkoxylated trimethylol propane
tri(meth)acrylates

Considered as belonging to the class of “higher valent (meth)acrylate-containing compounds” are furthermore, for the purposes of the afore-mentioned definition of c), the compounds of the family of (meth)acrylated polyesters as well as of the (meth)acrylated polyurethanes. The (meth)acrylated polyesters are the reaction products of OH-terminated polyester polyols, mostly of oligomeric origin, with (meth)acrylic acid, or the products of the reaction of carboxyl groups-containing polyester polyols, likewise mostly in oligomeric form, with OH groups-containing (meth)acrylates. The (meth)acrylated polyurethanes are conversion products of amine-terminated or hydroxyl-terminated (meth)acrylates with di-, tri- or polyisocyanates (for example, 1,6-hexamethylene diisocyanate, 2,4- or 2,6-toluylene diisocyanate, isophorone diisocyanate), the urea-, biuret- or alophanate-containing derivatives thereof, or the dimeric and trimeric compounds which originate from the monomeric compounds.

It should be further appreciated that a compound reactive to Tserevitinov hydrogens according to c) means epoxides, isocyanates, cyanates, aziridines, metal chelates or other compounds corresponding to the state of the art which are capable of bonding chemically to C—H-acidic compounds.

It should be appreciated that an initiator according to d) means compounds which, under action of thermal energy or high-energy radiation, are capable of decomposing into radicals and of starting a free-radical polymerisation. Examples of such initiators are azo compounds, peroxide compounds, aromatic α-hydroxyketones, aryl phosphor compounds, and similar radical initiators.

It should also be appreciated that a liquid, chemically inert medium according to e) means a liquid compound which is capable of detaching the polymer formed, or to emulsify or disperse it. Belonging to this group are esters, ketones, alcohols, hydrocarbons, cycloaliphatics, aromatics, water, or mixtures of these compounds.

The preparation of the inventive polymer compounds can be performed both in organic solvents (solution polymerisation) as well as in water (emulsion polymerisation) but also free of solvents by UV light or electron beam. Here, the manufacture and processing of the inventive polymers takes place in a known manner.

In the solvent-containing processes, the polymer is produced in a known manner in a liquid, chemically inert medium (component according to e)) from (meth)acrylates with Tserevitinov hydrogen, apolar (meth)acrylates and an initiator (the components according to a), b), d)) (solution polymerisation). Here, solutions of adhesive polymers having a typical solids content of 10-70%-wt are obtained. This solution is reacted with a compound according to c) which is reactive to Tserevitinov hydrogens. Subsequently, the solution can be processed on a coating plant with a downstream drying channel according to the state of the art, so as to yield a web-like adhesive or sealant.

In the water-based processes, (meth)acrylates with Tserevitinov hydrogen, apolar(meth)acrylates and an initiator (the components according to a) to c)) are emulsified with water. For this purpose, it may be expedient to use additional dispersing or emulsifying agents known to those skilled in the art. The reaction mixture is converted in a known manner to a polymer dispersion or emulsion having a solids content between 10 and 70%-wt. This dispersion can then be processed in a manner analogous to the solvent-based polymers to form web-like sealants and adhesives.

In the solvent-free processes a polymer syrup is prepared from components a) to c) in a known manner. Utilized as components c) are preferably di-, tri- or higher functional (meth)acrylates. The polymer syrup can subsequently be processed to adhesives and sealants on a coating apparatus with a downstream curing device, by means of high-energy radiation.

The inventive polymer composition can be employed as adhesive or sealant. Preferably, the inventive polymer composition is further processed to pressure sensitive adhesive tapes. Using the pressure sensitive adhesive tapes prepared with the aid of the inventive polymers, an initial adhesion of up to 50 N/25 mm on substrates with a polar surface, and of up to 20 N/25 mm on substrates with a nonpolar surface was measured.

### EXAMPLES

### 1. Preparation of a Solvent-Based, Chemically Inert Adhesive

250 parts by weight of isodecyl methacrylate and 250 parts by weight of 2-hydroxyethyl acrylate are dissolved in 450 parts by weight of ethyl acetate and, under introduction of nitrogen and stirring, heated till boiling. Subsequently, 5 parts by weight of azoisobutyronitrile, dissolved in 50 parts by weight of ethyl acetate, is metered thereto over a period of 1 hour. After the initiator has been added, the reaction mixture is left for 5 hours, under back flow. After cooling, an adhesive solution is obtained which has a solids content of 50%-wt. The residual monomer content amounts to maximally 2.5%-wt. 10 parts by weight of a 10% solution of titanium chelate in isopropanol is added to the adhesive solution. The solution is spread to form a film of 0.2 mm in thickness. After evaporation of the solvent, the film is dried at 90° C. for 10 min. A pressure-sensitive film is obtained.

2. Preparation of a Solvent-Free, Chemically Inert Adhesive

250 parts by weight of isodecyl methacrylate and 250 parts by weight of 2-hydroxyethyl acrylate are mixed with 5 parts by weight of IRGACURE® 819 (CIBA Spezialitatenchemie) and 2.5 parts by weight of tripropylene glycol diacrylate. After knife-coating a 0.5 mm thick layer onto a carrier film (PET), the former is cured in nitrogen atmosphere within 1 minute by means of a UV lamp (80 W/cm). A pressure sensitive adhesive film is obtained. Conversion amounts to 98%.

3. Preparation of a Solvent-Based Adhesive

250 parts by weight of isodecyl methacrylate, 150 parts by weight of 2-ethylhexyl acrylate, 50 parts by weight of 2-hydroxyethyl acrylate and 50 parts by weight of acrylic acid are dissolved in 450 parts by weight of ethyl acetate. The polymerisation and processing is performed in a manner analogous to Example 1. The solids content of the adhesive solution amounts to 50%-wt, the residual monomer content is maximally 2.5%-wt. After drying, a pressure sensitive adhesive film is obtained.

4. Preparation of a Solvent-Free Adhesive

250 parts by weight of isodecyl methacrylate, 200 parts by weight of 2-hydroxyethyl acrylate, 50 parts by weight of acrylic acid, 5 parts by weight of IRGACURE®819 (CIBA Spezialitätenchemie), and 2.5 parts by weight of tripropylene glycol diacrylate are mixed. Processing is performed in a manner analogous to Example 2. A pressure sensitive adhesive film is obtained. Conversion amounts to at least 98%.

5. Examination of the Resistance of the Adhesives to Reactive Cast Resins

The adhesive films were applied to an aluminium sheet and covered at their margins with a layer of isocyanate (HDI), so that the isocyanate was in contact with both the adhesive and the aluminium substrate. The samples were observed for 24 hours.

| Example | CO₂-formation | Adhesion to glass | Adhesion to Al |
|---|---|---|---|
| 1 | none | good | good |
| 2 | none | good | good |
| 3 | after 10 min | good | good |
| (Comparison) | | | |
| 4 | after 10 min | good | good |
| (Comparison) | | | |

The adhesives according to the invention are characterized by their high resistance to reactive substances. At the same time adhesion to polar substrates is not detrimentally affected compared to conventional (acrylic acid-containing) adhesives.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. A polymer composition which can be produced by polymerisation of
a) 1 to 50%-wt of polar(meth)acrylates with Tserevitinov hydrogen, said polymer(meth)acrylates being selected from the group consisting of 2-hydroxyethyl(meth)acrylate, 3-hydroxypropyl(meth)acrylate, 4-hydroxybutyl(meth)acrylate, PEG (meth)acrylates, PPG (meth)acrylates, 2-aminoethyl(meth)acrylate, 3-aminopropyl (meth)acrylate, 4-aminobutyl(meth)acrylate, reaction products of acrylic or methacrylic acid with bi-, tri- or higher functional alcohols, and ethoxylation, propoxylation and butoxylation products of acrylic or methacrylic acid with terminal hydroxy, amino, urethane or thio groups containing at least one active hydrogen;
b) 50 to 99%-wt of apolar(meth)acrylates;
c) in the presence of a bi-, tri- or higher functional (meth)acrylate, or of a (poly)functional compound which is reactive to Tserevitinov hydrogens and is selected from the group consisting of mono-, bi- and polyepoxides, mono-, bi- and polyaziridines and melamine and its derivatives, or of a mixture of two or more of the aforementioned compounds, the weight percentages indicated under a) to c) adding up to 100%-wt.;
d) with addition of 0.05 to 5%-wt. of an initiator, relative to the sum of the components of a) to c); and
e) up to 90%-wt. of a liquid, chemically inert medium, relative to the solid matter content of the sum of the components of a) to d).

2. The polymer composition according to claim 1, wherein said polar(meth)acrylates do not contain carboxyl groups.

3. The polymer composition according to claim 1, wherein said polar(meth)acrylates are hydroxy(meth)acrylates.

4. The polymer composition according to claim 1, wherein said polar(meth)acrylates are amino(meth)acrylates.

5. The polymer composition according to claim 1. wherein said apolar(meth)acrylates are esterification products of acrylic acid or methacrylic acid with monovalent alcohols or amines.

6. The polymer composition according to claim 5, wherein said apolar(meth)acrylates are alkyl(meth)acrylamides.

7. The polymer composition according to claim 6, wherein said apolar(meth)acrylates are esterification products of acrylic acid or methacrylic acid with monohydric alcohols having 6 to 15 C atoms.

8. The polymer composition according to claim 7, wherein said apolar(meth)acrylates are selected from the group consisting of methyl(meth)acrylate, ethyl(meth)acrylate, butyl(meth)acrylate, hexyl(meth)acrylate, isooctyl(meth)acrylate, 2-ethylhexyl(meth)acrylate, isodecyl(meth)acrylate and isobomyl(meth)acrylate.

9. The polymer composition according to claim 1, wherein said di-, tri- or higher functional (meth)acrylates are selected from the group consisting of the conversion products of (meth)acrylic acid with diols, triols or polyols, the analogous vinyl ethers or mixtures thereof, (meth)acrylated polyesters and (meth)acrylated polyurethanes.

10. The polymer composition according to claim 9, wherein said (meth)acrylated polyesters are conversion products of OH-terminated polyester polyols with (meth)acrylic acid or reaction products of carboxyl groups-containing polyester polyols with hydroxyl groups-containing (meth)acrylates.

11. The polymer composition according to claim 9, wherein said (meth)acrylated polyurethanes are conversion products of amine- or hydroxyl-terminated (meth)acrylates with diisocyanates or polyisocyanates.

12. The polymer composition according to claim 1, wherein said polymer composition contains a further compound which is reactive to Tserevitinov hydrogen and which is selected from the group consisting of mono-, di- and polyisocyanates.

13. A process for the production of a polymer composition according to claim 1, said process comprising a polymerisation reaction which is performed free of solvent, or in a liquid selected from the group consisting of water and an organic, inert solvent.

14. Use of the polymer composition according to claim 1 as an adhesive or as a sealant.

15. Use of the polymer composition according to claim 1 for the production of pressure sensitive adhesive tapes.

16. The polymer composition according to claim 7, wherein said apolar (meth)acrylates are esterification products of acrylic acid or methacrylic acid with monohydric alcohols having 6 to 10 C atoms.
